(19) United States
(12) Patent Application Publication
(10) Pub. No.: US 2026/0146896 A1
(43) Pub. Date: May 28, 2026

(54) HEAT SENSOR CIRCUIT

(71) Applicant: INDUSTRIAL TECHNOLOGY RESEARCH INSTITUTE, HSINCHU (TW)

(72) Inventors: Lu-Pu LIAO, Taoyuan City (TW); Cheng Ta CHAN, Tainan City (TW); Ting-Hao HSIAO, Tainan City (TW); Chun-Chieh WANG, Tainan City (TW)

(21) Appl. No.: 19/063,242

(22) Filed: Feb. 25, 2025

(30) Foreign Application Priority Data
Nov. 25, 2024 (TW) 113145406

(51) Int. Cl. G01J 5/24

(52) U.S. Cl. CPC G01J 5/24

(57) ABSTRACT

A heat sensor circuit includes a sensing pixel, a reference pixel, a sensing unit, and a voltage generation unit. The sensing pixel and the reference pixel are coupled with a first input terminal of the sensing unit. The voltage generation unit includes switch circuits and a voltage divider circuit that is coupled with the switch circuits and coupled between first and second supply voltages. The switch circuits include a first switch circuit outputting a first voltage to the sensing pixel based on the first supply voltage, a second switch circuit outputting a second voltage to the reference pixel based on the first supply voltage, and a third switch circuit outputting a third voltage to a second input terminal of the sensing unit based on the first supply voltage. The sensing unit generates an output voltage based on the current difference between sensing pixel and reference pixel.

### CROSS-REFERENCE TO RELATED APPLICATION

The present application is based on, and claims priority from, Taiwan Application Serial Number 113145406, filed Nov. 25, 2024, the disclosure of which is hereby incorporated by reference herein in its entirety.

### BACKGROUND

### Technical Field

The technical field relates to a heat sensor circuit with noise reduction circuit design.

### Description of Related Art

Today's high-pixel infrared sensors face the challenge of signal noise in their quest for higher resolution and faster response times. In order to achieve finer images, the pixel size of the element is continuously shrunk; however, this also leads to a reduction in signal intensity, which makes the impact from noise more significant.

Furthermore, shortening the circuit readout time to increase image update speed also causes a decrease in signal intensity, thus amplifying the noise impact. Moreover, the increased speed of circuit operation itself introduces additional noise. Therefore, the effective suppression of signal noise in the sensor chip is a key issue in improving the performance of infrared sensors.

### SUMMARY

According to one embodiment of the present application, a heat sensor circuit is provided. The heat sensor circuit includes a sensing pixel, a reference pixel, a sensing unit, and a voltage generating unit. The sensing pixel and the reference pixel are coupled at a first input terminal of the sensing unit. The voltage generating unit includes multiple switch circuits and a voltage dividing circuit that is coupled with the switch circuits. The voltage dividing circuit is further coupled between a first supply voltage and a second supply voltage. A first switch circuit in the switch circuits outputs, according to the first supply voltage, a first voltage to the sensing pixel, a second switch circuit in the switch circuits outputs, according to the first supply voltage, a second voltage to the reference pixel, and a third switch circuit in the switch circuits outputs, according to the first supply voltage, a third voltage to a second input terminal of the sensing unit. The sensing unit generates an output voltage according current difference between the sensing pixel and the reference pixel.

According to one embodiment of the present application, a heat sensor circuit is provided. The heat sensor circuit includes a sensing pixel array, a reference pixel array, multiple voltage generating units, and multiple sensing units. The voltage generating units are coupled with the sensing pixel array and the reference pixel array. Each of the sensing units is coupled with a corresponding one of the voltage generating units. Each of the voltage generating units outputs, according to a supply voltage, a first voltage, a second voltage and a third voltage to a corresponding one of the sensing pixel array, the reference pixel array and the sensing unit respectively.

### BRIEF DESCRIPTION OF THE DRAWINGS

The application can be more fully understood by reading the following detailed description of the embodiment, with reference made to the accompanying drawings as follows:

FIG. 1 is a schematic block diagram of a heat sensor circuit illustrated according to the embodiment of the present application.

FIG. 2 is a schematic diagram of the part corresponding to the heat sensor circuit in the FIG. 1 according to the embodiment of the present application.

FIG. 3 is a schematic diagram of the waveforms used in the heat sensor circuit corresponding to FIG. 1 to FIG. 2 according to the embodiment of the present application.

FIG. 4 is schematic diagram of part of the heat sensor circuit illustrated according to the embodiment of the present application.

FIG. 5 is a schematic diagram of part of the heat sensor circuit illustrated in another embodiment of the present application.

FIG. 6 is a schematic diagram of the part of the heat sensor circuit in another embodiment of the present application.

FIG. 7 is a schematic diagram of the part of the heat sensor circuit illustrated according to the embodiment of the present application.

### DETAILED DESCRIPTION

Some of the example embodiments will be described in detail in the accompanying drawings. The following descriptions refer to component symbols, and when the same component symbols appear in different drawings, they will be regarded as the same or similar components. These example embodiments are only a portion of the present application and do not reveal all of the ways in which the present application may be implemented. More specifically, these example embodiments are only examples of methods, devices, and systems within the scope of this patent application.

In the present disclosure, “connected” or “coupled” may refer to “electrically connected” or “electrically coupled.” “Connected” or “coupled” may also refer to operations or actions between two or more elements.

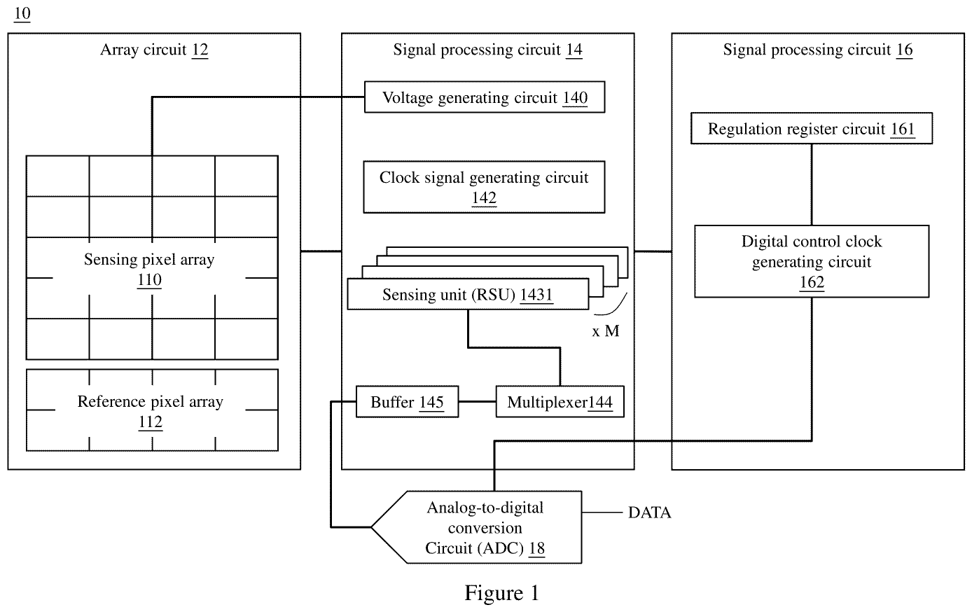

Reference is now made to FIG. 1. FIG. 1 is a schematic block diagram of the heat sensor circuit 10 illustrated according to the embodiment of the present application.

The heat sensor circuit 10 includes an array circuit 12, and the array circuit 12 includes a sensing pixel array 110 and a reference pixel array 112. In some embodiments, the sensing pixel array 110 is also referred to as a focal plane array (FPA) and is configured to receive thermal radiation (e.g., infrared radiation, IR) from an external scene. The thermal radiation incident on the sensing pixel array 110 changes the temperature of the sensing pixel array 110 and, consequently, the resistance value. Therefore, by measuring corresponding variations of current or voltage, induced by the change of resistance value, in the components of the pixel array 110, the data of temperature change can be further obtained.

The reference pixel array 112 has a configuration similar to that of the sensing pixel array 110, but the reference pixel array 112 is shielded from thermal radiation from the external scene. In this way, the reference pixel array 112 responds to the level of incident radiation from the external scene with essentially no change in temperature. Therefore, the reference pixel array 112 can be used as a reference for adjusting the variations of the sensing pixel array 110.

The heat sensor circuit 10 further includes a signal processing circuit 14 and a signal processing circuit 16. In some embodiments, to collaborate with the array circuit 12 to read out data related to changes in the resistance value of the sensing pixel array 110 caused by incident infrared radiation.

In some embodiments, the signal processing circuit 14 is configured as an analog circuit. As shown in the FIG. 1, the signal processing circuit 14 includes a voltage generating circuit 140, a clock signal generating circuit 142, and sensing units 1431-143M, a multiplexer 144 and a buffer 145.

In some embodiments, the voltage generating circuit 140 is configured to generate a bias (e.g., bias voltage or current) applied to the sensing pixel array 110 to measure resistance value of the sensing pixel array 110 (or any variation thereof). In some embodiments, the voltage generating circuit 140 is configured to set the bias based on calibration data (e.g., an adjustment value stored as binary bits) stored in calibration memory (not shown). In some other embodiments, the calibration data may also be provided directly to the voltage generating circuit 140 from a source outside of the heat sensor circuit 10 (e.g., from an external processor and/or memory).

The clock signal generating circuit 142 is configured to provide stable clock signals to circuitries in the array circuit 12 and the signal processing circuit 14 to ensure synchronous operation with each other, for example, activation of each or each group of pixels (e.g., a row of sensing pixels) in the sensing pixel array 110, each or each group of pixels (e.g., a row of reference pixels) in the reference pixel array 112, and corresponding ones in the sensing unit 1431-143M. In some embodiments, the clock signal generating circuit 142 further controls switches (not shown) connected between the array circuit 12 and the signal processing circuit 14 to transmit operational bias voltages to the pixel to be measured. In some embodiments, the clock signal generating circuit 142 also provides signals to the signal processing circuit 16 to control the data sampling frequency and/or to manipulate the analog-digital conversion process of the signal. Moreover, the signal processing circuit 16 can be used to control the activation and the shutdown of sensors, increasing the flexibility of the overall system.

Each one in the sensing units 1431 to 143M generates an output voltage Vo according to the voltage of one terminal of the pixels in the reference pixel array 112 and the voltage of one terminal of the pixels in the sensing pixel array 110, in which the output voltage is induced by voltage/current changes in the sensing pixel array 110 due to thermal radiation.

The multiplexer 144, the buffer 145 and the analog-to-digital conversion circuit (ADC) 18 in the heat sensor circuit 10 are configured to cooperate together to convert the output voltage Vo to digital data DATA.

The signal processing circuit 16 includes a regulation register circuit 161 and a digital control clock generating circuit 162. In some embodiments, the regulation register circuit 161 is configured to calibrate and/or control the output of the analog-to-digital conversion circuit 18 to ensure its accuracy and stability. For example, the digital control clock generating circuit 162 generates a clock signal CDEL based on the control data of the regulation register circuit 161 to control an analog-to-digital conversion circuit 18 to convert the voltages outputs by the sensing units 1431 to 143M to digital data DATA.

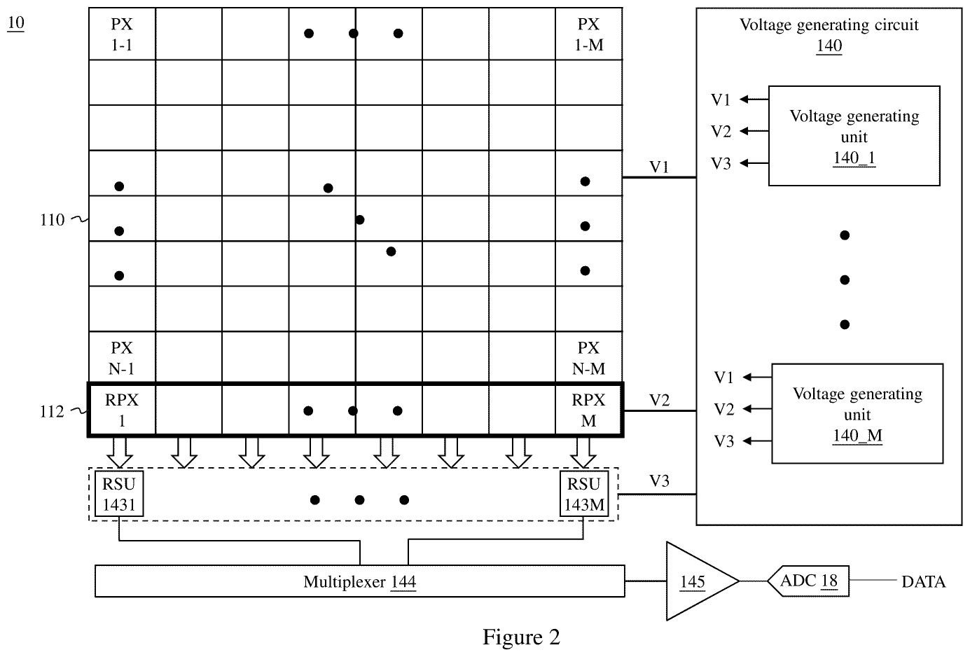

Reference is made to FIG. 2 to FIG. 7 to describe the operation of the heat sensor circuit 10 according to the embodiment in this application. For the sake of brevity, the specific operations of similar components that have been discussed in detail in the previous paragraphs are omitted from this article, unless it is necessary to describe the collaborative relationships of the components shown in FIG. 2 to FIG. 7.

FIG. 2 is a schematic diagram of the part corresponding to the heat sensor circuit 10 in the FIG. 1 according to the embodiment of the present application.

The sensing pixel array 110 includes multiple sensing pixels PX1-1 to PXN-M arranged at the intersection of the array with N rows and M columns, in which N and M are natural numbers. The reference pixel array 112 includes reference pixels RPX1 to RPXM arranged in the M columns. In some embodiments, the sensing pixels of the same column are coupled with the reference pixels and the corresponding sensing units that are in the same column. For example, the sensing pixels PX1-1 to PXN-1 are coupled with the reference pixel RPX1 and the sensing unit 1431, and so on. In some embodiments, the reference pixel array 112 includes multiple reference pixels in rows, in which one or more rows of reference pixels can be selectively connected to the corresponding row or rows in the sensing pixel array 110 to provide pixel signal(s) indicating the level of reference thermal radiation intensity.

The sensing units 1431 to 143M are coupled with the multiplexer 144. The buffer 145 is coupled between the multiplexer 144 and the analog-to-digital conversion circuit 18.

In the embodiment of FIG. 2, the voltage generating circuit 140 includes multiple voltage generating units 140_1 to 140_M that are coupled with the sensing pixel array 110 and the reference pixel array 112. In some embodiments, as shown in FIG. 2, the number of voltage generating units is the same as the number of sensing units.

In some embodiments, each of the voltage generating units 140_1 to 140_M is configured to output, according to the supply voltage, such as VDD, the output voltage V1, the voltage V2, and the voltage V3 to the corresponding one in the sensing pixel array 110, the reference pixel array 112 and the sensing units 1431 to 143M respectively.

In some embodiments, each of the voltage generating units 140_1 to 140_M supplies the voltage V1 to a corresponding sensing pixel.

For instance, each of the voltage generating units 140_1 to 140_M is coupled with a corresponding one in the sensing pixels PX1-1 to PXN-M. For example, the voltage generating unit 140_1 is coupled with the sensing pixels PX1-1 to PXN-1 located in the same column, and the voltage generating unit 140_M is coupled with the sensing pixels PX1-M to PXN-M located in the same column, and so on.

Similarly, one of the voltage generating units 140_1 to 140_M is coupled with the reference pixel and the sensing unit that are located in the same column. For example, the voltage generating unit 140_1 is coupled with the reference pixel RPX1 and the corresponding sensing unit 1431 that are in the same column, and so on.

In some other embodiments, different from the heat sensor circuit 10 having the number M of sensing units and the number M of voltage generating units of the embodiment in FIG. 2, the heat sensor circuit can have the number N of sensing units and the number N of voltage generating units.

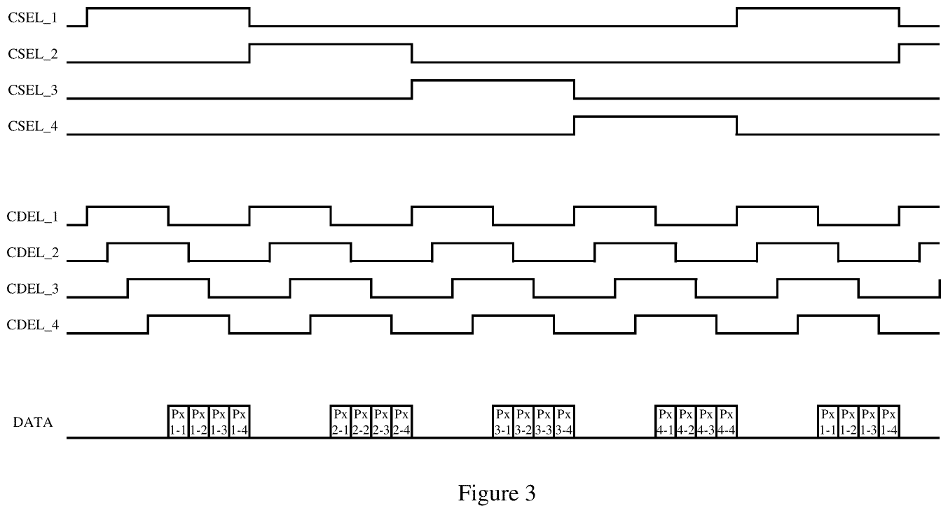

Reference is now made to both FIG. 2 and FIG. 3 to illustrate the operation of the heat sensor circuit 10. FIG. 3 is a schematic diagram of the waveforms used in the heat sensor circuit corresponding to FIG. 1 to FIG. 2 according to the embodiment of the present application.

In some embodiments, the clock signal CSEL_1 to CSEL4 and CDEL_1 to CDEL4 can be generated by the clock signal generating circuit 142 or the digital control clock generating circuit 162. In some embodiments, the heat sensor circuit 10 may include a processor, memory, or other logic circuits (not shown) for performing various operations associated with the heat sensor circuit 10 based on configuration data stored in memory. For example, in some embodiments, the processor controls, according to the sensing operation of the heat sensor circuit 10, the clock signal generating circuit 142 and/or the digital control clock generating circuit 162 to generate the corresponding clock signal.

The heat sensor circuit 10 accesses selectively, in response to the rising edge of the clock signal CSEL_1, a row of the sensing pixels (e.g., PX1-1 to PX1-4) at a time. Then, the voltage generating units 140_1 to 140_4 transmits respectively, in response to the falling edge of the clock signal CDEL_1 to CDEL_4, the corresponding voltage V1 to the sensing pixels PX1-1 to PX1-4 (the voltage V1 for each sensing pixel may not necessarily be the same), the corresponding voltage V2 to the reference pixels RPX1 to RPX4 (the voltage V2 for each reference pixel may not necessarily be the same), and the corresponding voltage V3 to the sensing units 1431 to 1434 (the voltage V3 for each sensing unit may not necessarily be the same). In some embodiments, the sensing units 1431 to 1434 further generate the output voltage Vo according to the current difference between a corresponding one in the sensing pixels PX1-1 to PX1-4 and a corresponding one in the reference pixels RPX1 to RPX4 respectively. The analog-to-digital conversion circuit 18 converts respectively, in response to the falling edge of the clock signal CDEL_1 to CDEL_4, the output voltages Vo from the sensing units 1431 to 1434 into corresponding content in the digital data DATA, as shown in FIG. 3. The operations of sequentially accessing the other rows of the sensing pixel array 110 are similar to the operation of the heat sensor circuit 10 responsive to the clock signal CSEL_1. Therefore, repetitious descriptions are omitted here.

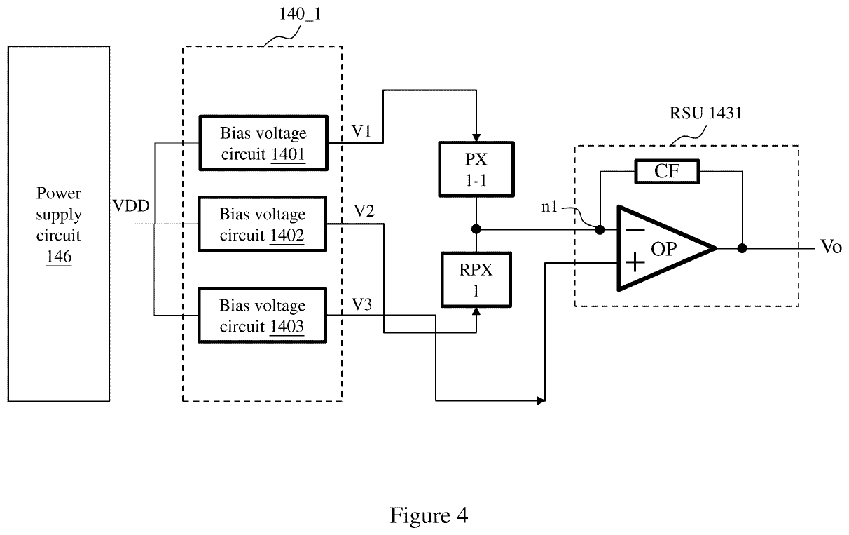

Reference is now made to FIG. 4. FIG. 4 is schematic diagram of part of the heat sensor circuit 10 according to the embodiment of the present application. The heat sensor circuit 10 further includes a power supply circuit 146. The power supply circuit 146 is configured to provide the supply voltage VDD to the voltage generating units 140_1 to 140_M.

As shown in FIG. 4, the voltage generating unit 140_1 includes bias voltage circuits 1401 to 1403. In some embodiments, one output terminal of the power supply circuit 146 is coupled with an input terminal of each in the bias voltage circuits 1401 to 1403 and outputs the supply voltage VDD.

In some embodiments, the bias voltage circuit 1401 outputs the voltage V1 according to the supply voltage VDD to the first terminal of the sensing pixel PX1-1. The bias voltage circuit 1402 outputs the voltage V2 according to the supply voltage VDD to the first terminal of the reference pixel RPX1. The bias voltage circuit 1403 outputs the voltage V3 according to the supply voltage VDD to the positive input terminal of the amplifier OP in the sensing unit 1431. The second terminal of the sensing pixel PX1-1 is coupled with the second terminal of the reference pixel RPX1 at the terminal n1 and further coupled with the negative input of the amplifier OP. The capacitor CF and the amplifier OP are connected in parallel between the terminal n1 and the output of the amplifier OP.

In operation, according to some embodiments, the output voltage Vo of the amplifier OP of the sensing unit can be expressed by equation (1):

$$Vo = \frac{\begin{matrix}\frac{[ ( V 1 + noise 1 ) - ( V 3 + noise 3 ) ]}{RS} - \\ \frac{[ ( V 3 + noise 3 ) - ( V 2 + noise 2 ) ]}{RB}\end{matrix}}{CCF} * T \qquad ( 1 )$$

where noise1 represents power supply noise that is transmitted to the sensing pixel PX1-1 and associated with the supply VDD; noise2 represents power supply noise that is transmitted to the reference pixel RPX1 and associated with the supply VDD; noise3 represents the power supply noise that is transmitted to the amplifier OP and associated with the supply VDD; RS represents the resistance value of the sensing pixel PX1-1; RB represents the resistance value of the reference pixel RPX1; CCF represents the capacitance value of the capacitor CF; and T represents the integration time of the circuit.

In the embodiment of the present application, since the input terminals of the bias voltage circuits 1401 to 1403 are all coupled with the same voltage source—the power supply circuit 146, the power supply noises noise1 to noise3 are eliminated due to the symmetrical configuration. In other words, noise1 is essentially equal to about noise2, and noise2 is essentially equal to about noise3. Correspondingly, the output voltage Vo of the amplifier OP can be expressed by equation (2):

$$Vo = \frac{\frac{( V 1 - V 3 )}{RS} - \frac{( V 3 - V 2 ) ]}{RB}}{CCF} * T \qquad ( 2 )$$

With the above configuration, the noise in the output voltage Vo can be greatly reduced, thereby greatly improving the signal-to-noise ratio of the signal. In some embodiments, the noise in the output voltage Vo is reduced by more than 40%.

In some embodiments, the heat sensor circuit 10 controls the bias voltage circuit 1402 and the bias voltage circuit 1403 through control signals to make the voltage V2 and the voltage V3 equal to each other, so that the output voltage Vo is more directly responsive to the change in the resistance of the sensing pixel PX1-1 caused by thermal radiation, and to reduce the influence of other circuit components on the accuracy of the output voltage Vo.

The configurations of FIG. 4 are given for illustrative purposes. The various implementations of FIG. 4 are expected to be in the scope of one embodiment in the present application. For example, in some embodiments, the bias voltage circuits 1401 to 1403 can be any suitable voltage conversion circuits.

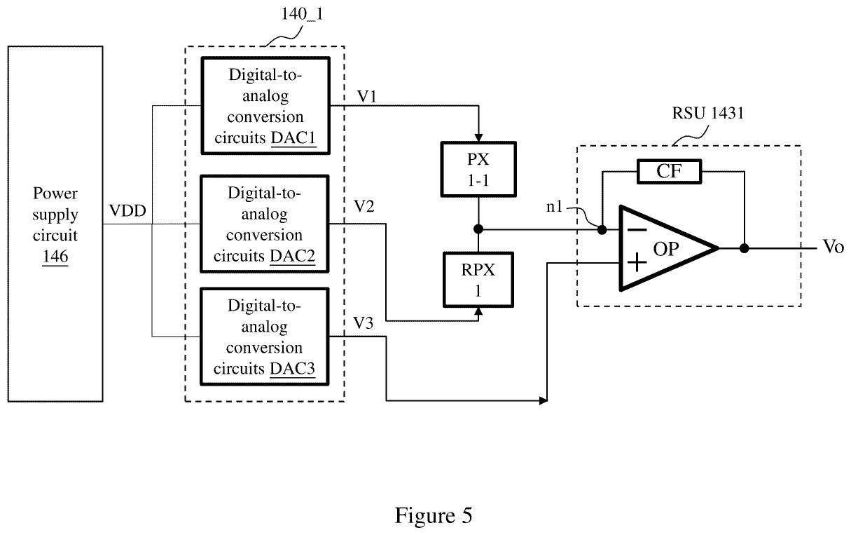

Reference is now made to FIG. 5. FIG. 5 is a schematic diagram of part of the heat sensor circuit 10 illustrated in another embodiment of the present application.

In the embodiment of FIG. 5, the bias voltage circuits 1401 to 1403 corresponding to FIG. 4 can be digital-to-analog conversion circuits DAC1 to DAC3. In some embodiments, the digital-to-analog conversion circuits DAC1 to DAC3 program, in response to the control signals of the processor, the voltages V1, V2, and V3 to conform to the sensing configuration of the heat sensor circuit 10.

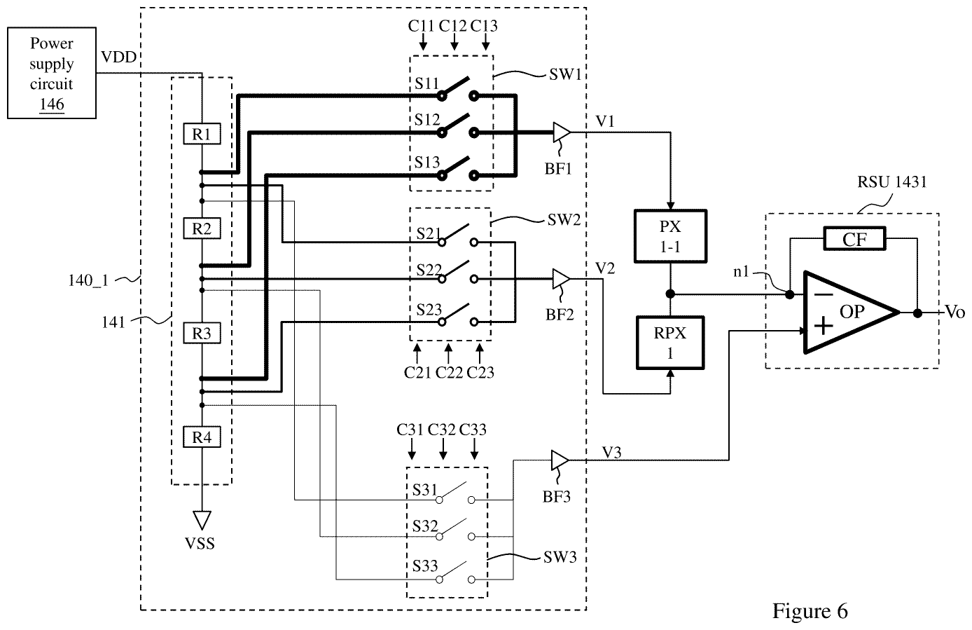

Reference is now made to FIG. 6. FIG. 6 is a schematic diagram of the part of the heat sensor circuit 10 in another embodiment of the present application.

As shown in FIG. 6, the voltage generating unit 140_1 includes a voltage dividing circuit 141. The voltage dividing circuit 141 is coupled between the supply voltage VDD and the supply voltage VSS and to receive the supply voltage VDD. The voltage dividing circuit 141 includes multiple resistors R1 to R4 that are connected in series with each other. In some embodiments, the resistance values of the resistors R1 to R4 are the same.

The voltage generating unit 140_1 also includes multiple switch circuits SW1 to SW3 and buffer circuits BF1 to BF3. The switch circuits SW1 to SW3 are connected to multiple output terminals of the voltage dividing circuit 141. As shown in FIG. 6, each of the switch circuits SW1 to SW3 has multiple input terminals, and each of the input terminals is coupled between two adjacent resistors in the voltage dividing circuit 141. In other words, the input terminal of each of the switch circuits SW1 to SW3 is coupled between the supply voltages VDD and VSS. The output terminals of the switch circuits SW1 to SW3 are respectively coupled with the corresponding one in the buffer circuits BF1 to BF3, as shown in FIG. 6. In some embodiments, the buffer circuits BF1 to BF3 are respectively configured to enhance the signals received from the switch circuits SW1 to SW3 or to suppress the surge wave when the switches are switched, and to output the signals.

As shown in FIG. 6, one terminal of the switch circuit SW1 is coupled with a corresponding one terminal of the switch circuit SW2 and a corresponding one terminal of the switch circuit SW3.

Specifically, the switch circuit SW1 is coupled between the voltage dividing circuit 141 and the sensing pixel PX1-1, and includes switches S11 to S13 that respond to control signals C11 to C13 respectively. The first terminal of the switch S11 is coupled between the resistors R1 and R2; the first terminal of the switch S12 is coupled between the resistors R2 and R3; and the first terminal of the switch S13 is coupled between the resistors R3 and R4. The second terminals of the switches S11 to S13 are coupled with each other at the output terminal of the switch circuit SW1, and are further coupled with the buffer circuit BF1 and the sensing pixel PX1-1.

Similarly, the switch circuit SW2 is coupled between the voltage dividing circuit 141 and the reference pixel RPX1, and includes switches S21 to S23 that respond to control signals C21 to C23 respectively. The first terminal of the switch S21 is coupled between the resistors R1 and R2; the first terminal of the switch S22 is coupled between the resistors R2 and R3; and the first terminal of the switch S23 is coupled between the resistors R3 and R4. The second terminals of the switches S21 to S23 are coupled with each other at the output terminal of the switch circuit SW2, and are further coupled with the buffer circuit BF2 and the reference pixel RPX1.

The switch circuit SW3 is coupled between the voltage dividing circuit 141 and the positive input terminal of the amplifier OP, and includes switches S31 to S33 that respond to control signals C31 to C33 respectively. The first terminal of the switch S31 is coupled between the resistors R1 and R2; the first terminal of the switch S32 is coupled between the resistors R2 and R3; and the first terminal of the switch S23 is coupled between the resistors R3 and R4. The second terminals of the switches S31 to S33 are coupled with each other at the output terminal of the switch circuit SW3, and are further coupled with the buffer circuit BF3 and the positive input terminal of the amplifier OP.

In some embodiments, the voltage generating unit 140_1 programs, in response to the control signals C11 to C13, C21 to C23, C31 to C33, the voltages V1 to V3. For example, the switch circuits SW1 to SW3 are configured to output one of the voltages V1 to V3 at its output terminal according to bias voltages at multiple output terminals of the voltage dividing circuit 141.

For example, in the embodiment of FIG. 6, the switches S11 to S13 in the switch circuit SW1 are turned on or off in response to the control signals C11 to C13 respectively to output the bias voltages at the output terminals of the voltage dividing circuit 141 as the voltage V1 to the sensing pixel PX1-1 at the output terminal of the switch circuit SW1. In some embodiments, when the voltage of the supply voltage VDD is, for example, 1 volt, and the resistance values of the resistors R1 to R4 are equal, the bias voltage between the resistors R1 and R2 is 0.75 volts, the bias voltage between the resistors R2 and R3 is 0.5 volts, and the bias voltage between the resistors R3 and R4 is 0.25 Volts. Therefore, in the embodiment of the switch S11 being responsive to the control signal C11 and turned on and the switches S12 to S13 being responsive to the control signals C12 to C13 and turned off, the switch circuit SW1 outputs the voltage of 0.75 volts as the voltage V1 to the sensing pixel PX1-1, and so on. The configurations of the switch circuits SW2 and SW3 are similar to that of the switch circuit SW1. Therefore, repetitious descriptions are omitted here.

In some embodiments, the control signals C11 to C13, C21 to C23 and C31 to 33 are appropriately configured by matching the operation of the heat sensor circuit 10, and the voltages V1 to V3 are different from each other.

In other embodiments, as previously discussed, the voltage V2 and the voltage V3 are the same. For example, when the switches, such as the switches S21 and S31, that are coupled between the same adjacent resistors are turned on at the same time, the switch circuits SW2 and SW3 output the voltages V2 and V3 that have the same voltage value.

The configurations of FIG. 6 are given for illustrative purposes. The various implementations of FIG. 6 are expected to be in the scope of one embodiment in this application. For example, in some embodiments, the resistors R1 to R4 are configured with different resistance values according to the desired combination of bias voltages. In other embodiments, the voltage dividing circuit 141 may include a number of the resistors not equal to 4. In some other embodiments, each of the switch circuits SW1 to SW3 may include a number of switches not equal to 3.

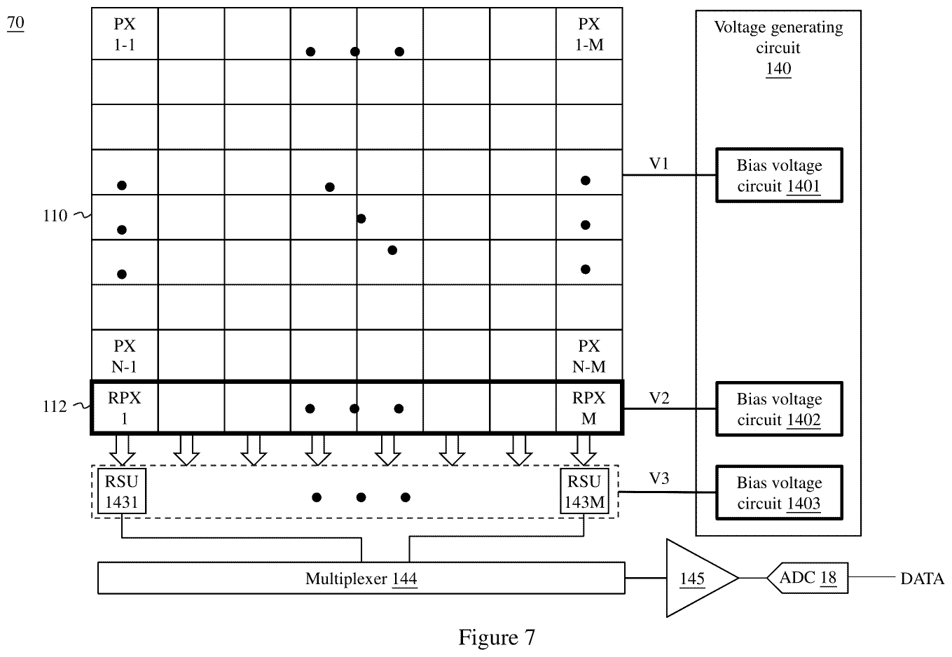

Reference is now made to FIG. 7. FIG. 7 is a schematic diagram of the part of the heat sensor circuit 70 illustrated according to the embodiment of the present application. In some embodiments, the configurations of the heat sensor circuit 70 are related to the configuration of the heat sensor circuit described earlier in this application, such as the heat sensor circuit 10. In contrast to the embodiments of FIGS. 1 to 6, similar components in FIG. 7 are indicated with the same reference number for ease of understanding.

Compared with the heat sensor circuit 10 in FIG. 2 and FIG. 3, which has multiple voltage generating units and each includes several bias voltage circuits 1401 to 1403, the voltage generating circuit 140 in the embodiments of FIG. 7 includes bias voltage circuits 1401 to 1403. In some embodiments, the bias voltage circuits 1401 to 1403 output, according to the supply voltage VDD, the voltage V1 to the sensing pixel array 110, the voltage to the reference pixel array 112, and the voltage V3 to the sensing units 1431 to 143M respectively.

This present application provides a heat sensor circuit for the purpose of effectively reducing noise to infrared sensor, while avoiding significant cost increases. The present application adopts a common-voltage source bias mechanism to effectively suppress power supply noise from interfering with the system, which can effectively suppress power supply noise and reduce the amount of noise by more than 40%.

Although the present application has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims.

What is claimed is:

1. A heat sensor circuit, comprising:
a sensing pixel and a reference pixel;
a sensing unit, wherein the sensing pixel is coupled with the reference pixel at a first input terminal of the sensing unit; and
a voltage generating unit, comprising a plurality of switch circuits and a voltage dividing circuit that is coupled with the plurality of switch circuits, the voltage dividing circuit being further coupled between a first supply voltage and a second supply voltage,
wherein a first switch circuit in the plurality of switch circuits is configured to output, according to the first supply voltage, a first voltage to the sensing pixel, a second switch circuit in the plurality of switch circuits is configured to output, according to the first supply voltage, a second voltage to the reference pixel, and a third switch circuit in the plurality of switch circuits is configured to output, according to the first supply voltage, a third voltage to a second input terminal of the sensing unit,
wherein the sensing unit is further configured to generate an output voltage according to a voltage at the first input terminal and a voltage of the second input terminal.

2. The heat sensor circuit of claim 1, wherein the sensing unit comprises an amplifier, wherein the first input terminal of the sensing unit is a negative input terminal of the amplifier, and the second input terminal of the sensing unit is a positive input terminal of the amplifier.

3. The heat sensor circuit of claim 2, wherein the amplifier is connected with a capacitor in parallel.

4. The heat sensor circuit of claim 1, wherein a plurality of input terminals of each in the plurality of switch circuits are coupled between the first supply voltage and the second supply voltage,
wherein the first switch circuit is configured to output, in response to a plurality of first control signals, the first voltage at an output terminal of the first switch circuit,
the second switch circuit is configured to output, in response to a plurality of second control signals, the second voltage at an output terminal of the second switch circuit, and
the third switch circuit is configured to output, in response to a plurality of third control signals, the third voltage at an output terminal of the third switch circuit.

5. The heat sensor circuit of claim 1, where the first voltage, the second voltage, and the third voltage are different from each other.

6. The heat sensor circuit of claim 1, where the second voltage and the third voltage are the same.

7. The heat sensor circuit of claim 1, wherein the voltage dividing circuit comprises a plurality of resistors connected in series with each other,
wherein each one in a plurality of input terminals of each one in the plurality of switch circuits is coupled between two corresponding adjacent ones in the plurality of resistors.

8. The heat sensor circuit of claim 7, wherein resistance values of the plurality of resistors are the same.

9. The heat sensor circuit of claim 8, wherein the first switch circuit comprises a plurality of first switches, wherein each of the plurality of first switches is configured to be turned on in response to a corresponding one in a plurality of first control signals to output one of a plurality of bias voltages from the voltage dividing circuit as the first voltage.

10. The heat sensor circuit of claim 9, wherein the second switch circuit comprises a plurality of second switches, wherein each of the plurality of second switches is configured to be turned on, in response to a corresponding one in a plurality of second control signals to output one of the plurality of bias voltages from the voltage dividing circuit as the second voltage,
wherein the third switch circuit comprises a plurality of third switches, each of the plurality of third switches is configured to be turned on in response to a corresponding one in a plurality of third control signals to output one of the plurality of bias voltages from the voltage dividing circuit as the third voltage.

11. The heat sensor circuit of claim 1, further comprising:
a power supply circuit, coupled with an input terminal of the voltage dividing circuit, and configured to provide the first supply voltage at the input terminal,
wherein a first output terminal, a second output terminal and a third output terminal of the voltage dividing circuit are coupled with the first switch circuit, the second switch circuit and the third switch circuit.

12. A heat sensor circuit, comprising:
a sensing pixel array and a reference pixel array;
a plurality of voltage generating units that are coupled with the sensing pixel array and the reference pixel array; and
a plurality of sensing units, each of the plurality of sensing units being coupled with a corresponding one of the voltage generating units,
wherein each of the plurality of voltage generating units is configured to output, according to a supply voltage, a first voltage, a second voltage and a third voltage to a corresponding one of the sensing pixel array, the reference pixel array and the sensing unit respectively.

13. The heat sensor circuit of claim 12, wherein a number of the plurality of sensing units and a number of the plurality of voltage generating units are equal.

14. The heat sensor circuit of claim 12, comprising:
a power supply circuit that is coupled with the plurality of voltage generating units to provide the supply voltage.

15. The heat sensor circuit of claim 12, wherein the second voltage is the same as the third voltage.

16. The heat sensor circuit of claim 12, wherein the sensing pixel array comprises a plurality of sensing pixels, and the reference pixel array comprises a plurality of reference pixels;
wherein each of the plurality of voltage generating units comprises:
a first bias voltage circuit, a second bias voltage circuit and a third bias voltage circuit that are different from each other,
wherein the first bias voltage circuit is configured to output, according to the supply voltage, the first voltage to one of the plurality of sensing pixels,
the second bias voltage circuit is configured to output, according to the supply voltage, the second voltage to one of the plurality of reference pixels, and
the third bias voltage circuit is configured to output, according to the supply voltage, the third voltage to the plurality of sensing units.

17. The heat sensor circuit of claim 16, wherein the first bias voltage circuit to the third bias voltage circuit are digital-to-analog conversion circuits.

18. The heat sensor circuit of claim 12, wherein each of the plurality of voltage generating units comprises:
a voltage dividing circuit configured to receive the supply voltage; and
a plurality of switch circuits, coupled with the voltage dividing circuit, and configured to output, according to a plurality bias voltages of the voltage dividing circuit, one of the first voltage to the third voltages at an output terminal thereof.

19. The heat sensor circuit of claim 18, wherein each of the plurality of switch circuits comprises a plurality of switches,
wherein a number of the plurality of switches is equal to 3.

20. The heat sensor circuit of claim 12, wherein each of the plurality of voltage generating units comprises:
a voltage dividing circuit configured to receive the supply voltage;
a first switch circuit, coupled between the voltage dividing circuit and the sensing pixel array, and comprising a plurality of first switches;
a second switch circuit, coupled between the voltage dividing circuit and the reference pixel array, and comprising a plurality of second switches; and
a third switch circuit, coupled between the voltage dividing circuit and one of the plurality of sensing units, and comprising a plurality of third switches,
wherein each of the plurality of first switches is coupled with a corresponding one in the plurality of second switches and a corresponding one in the plurality of third switches.

21. The heat sensor circuit of claim 20, wherein one of the plurality of second switches and one of the plurality of third switches are configured to be turned on at the same time to output the second voltage and the third voltage that are identical to each other.
